(19) United States
(12) Patent Application Publication
(10) Pub. No.: US 2026/0129667 A1
(43) Pub. Date: May 7, 2026

(54) INDICATING CURRENT AND FUTURE ASSOCIATED IDENTIFIERS FOR BEAM PREDICTION

(71) Applicant: QUALCOMM Incorporated, San Diego, CA (US)

(72) Inventors: Hamed PEZESHKI, San Diego, CA (US); Rajeev KUMAR, San Diego, CA (US); Aziz GHOLMIEH, Del Mar, CA (US)

(21) Appl. No.: 19/380,284

(22) Filed: Nov. 5, 2025

Related U.S. Application Data
(60) Provisional application No. 63/717,750, filed on Nov. 7, 2024.

(51) Int. Cl. H04W 72/56; H04W 24/10; H04W 28/02

(52) U.S. Cl. CPC H04W 72/56; H04W 24/10; H04W 28/0231

(57) ABSTRACT

Methods, systems, and devices for wireless communications are described. A user equipment (UE) may receive a control message that includes a list of associated identifiers (IDs), and the control message may further indicate whether each associated ID included in the list is a current associated ID or a future associated ID (e.g., whether a respective associated ID represents a current or future network-side additional condition). In some aspects, the information indicating whether an associated ID is a current of future associated ID may be conveyed to the UE explicitly or implicitly. In some examples, the UE may receive an indication of a priority across associated IDs included in the list. Additionally, or alternatively, the UE may receive an indication of a priority across inference configurations for one or more current associated IDs. The priority may be configured across associated IDs and used to determine which associated ID(s) to prioritize.

### CROSS REFERENCES

The present Application for Patent claims benefit of U.S. Provisional Patent. Application No. 63/717,750 by PEZESHKI et al., entitled “INDICATING CURRENT AND FUTURE ASSOCIATED IDENTIFIERS FOR BEAM PREDICTION,” filed Nov. 7, 2024, assigned to the assignee hereof, and expressly incorporated herein.

### FIELD OF TECHNOLOGY

The following relates to wireless communications, including indicating current and future associated identifiers for beam prediction.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a user equipment (UE) is described. The method may include receiving a first control message indicating, a set of associated identifiers, one or more configurations for prediction operations or one or more parameters associated with the prediction operations, whether one or more of the set of associated identifiers are associated with a first set of additional conditions of a network entity or a second set of additional conditions, transmitting a reporting message including an indication of whether at least one set of machine learning configurations or at least one set of prediction parameters from the one or more parameters is applicable for the prediction operations, where the at least one set of machine learning configurations or the at least one set of prediction parameters is applicable in accordance with the set of associated identifiers, the one or more configurations, the one or more parameters, whether the one or more of the set of associated identifiers are associated with the first set of additional conditions or the second set of additional conditions, or any combination thereof, receiving a second control message activating one or more machine learning configurations in accordance with the reporting message, and using the one or more machine learning configurations for the prediction operations in accordance with the at least one set of machine learning configurations indicated by the reporting message.

A UE for wireless communication is described. The UE may include one or more memories storing processor executable code, and one or more processors coupled with the one or more memories. The one or more processors may individually or collectively be operable to execute the code to cause the UE to receive a first control message indicating, a set of associate identifiers, one or more configurations for prediction operations or one or more parameters associate with the prediction operations, whether one or more of the set of associate identifiers are associated with a first set of additional conditions of a network entity or a second set of additional conditions, transmit a reporting message including an indication of whether at least one set of machine learning configurations or at least one set of prediction parameters from the one or more parameters is applicable for the prediction operations, where the at least one set of machine learn configurations or the at least one set of prediction parameters is applicable in accordance with the set of associated identifiers, the one or more configurations, the one or more parameters, whether the one or more of the set of associated identifiers are associated with the first set of additional conditions or the second set of additional conditions, or any combination thereof, receive a second control message activating one or more machine learning configurations in accordance with the reporting message, and used the one or more machine learning configurations for the prediction operations in accordance with the at least one set of machine learning configurations indicated by the reporting message.

Another UE for wireless communication is described. The UE may include means for receiving a first control message indicating, a set of associated identifiers, one or more configurations for prediction operations or one or more parameters associated with the prediction operations, and/or whether one or more of the set of associated identifiers are associated with a first set of additional conditions of a network entity or a second set of additional conditions, means for transmitting a reporting message including an indication of whether at least one set of machine learning configurations or at least one set of prediction parameters from the one or more parameters is applicable for the prediction operations, where the at least one set of machine learning configurations or the at least one set of prediction parameters is applicable in accordance with the set of associated identifiers, the one or more configurations, the one or more parameters, whether the one or more of the set of associated identifiers are associated with the first set of additional conditions or the second set of additional conditions, or any combination thereof, means for receiving a second control message activating one or more machine learning configurations in accordance with the reporting message, and means for using the one or more machine learning configurations for the prediction operations in accordance with the at least one set of machine learning configurations indicated by the reporting message.

A non-transitory computer-readable medium storing code for wireless communication is described. The code may include instructions executable by one or more processors to receive a first control message indicating, a set of associate identifiers, one or more configurations for prediction operations or one or more parameters associate with the prediction operations, whether one or more of the set of associate identifiers are associated with a first set of additional conditions of a network entity or a second set of additional conditions, transmit a reporting message including an indication of whether at least one set of machine learning configurations or at least one set of prediction parameters from the one or more parameters is applicable for the prediction operations, where the at least one set of machine learn configurations or the at least one set of prediction parameters is applicable in accordance with the set of associated identifiers, the one or more configurations, the one or more parameters, whether the one or more of the set of associated identifiers are associated with the first set of additional conditions or the second set of additional conditions, or any combination thereof, receive a second control message activating one or more machine learning configurations in accordance with the reporting message, and used the one or more machine learning configurations for the prediction operations in accordance with the at least one set of machine learning configurations indicated by the reporting message.

In some examples of the method, UEs, and non-transitory computer-readable medium described herein, the at least one set of machine learning configurations or the at least one set of prediction parameters from the one or more parameters may be ready for one or more prediction operations, the at least one set of machine learning configurations or the at least one set of prediction parameters from the one or more parameters may be obtainable for one or more prediction operations after a duration, and the at least one set of machine learning configurations or the at least one set of prediction parameters from the one or more parameters may be not applicable for one or more prediction operations.

In some examples of the method, UEs, and non-transitory computer-readable medium described herein, the first set of additional conditions includes a current set of additional conditions and the second set of additional conditions includes a future set of additional conditions of the network entity.

In some examples of the method, UEs, and non-transitory computer-readable medium described herein, the first set of additional conditions corresponds to a serving cell associated with the network entity and the second set of additional conditions corresponds to an adjacent cell associated with a second network entity.

In some examples of the method, UEs, and non-transitory computer-readable medium described herein, the one or more configurations include the set of associated identifiers and the one or more configurations include one or more channel state information report configurations that include predictive information.

In some examples of the method, UEs, and non-transitory computer-readable medium described herein, the prediction operations include a beam prediction or a channel state information (CSI) prediction, or any combination thereof.

In some examples of the method, UEs, and non-transitory computer-readable medium described herein, the first control message indicates a priority of each of the one or more of the set of associated identifiers and the method, apparatuses, and non-transitory computer-readable medium may include further operations, features, means, or instructions for selecting at least one associated identifier from the one or more of the set of associated identifiers in accordance with the priority.

In some examples of the method, UEs, and non-transitory computer-readable medium described herein, the first control message indicates a first associated identifier of the one or more of the set of associated identifiers for the first set of additional conditions, and the first control message further indicates a priority of one or more channel state information report configurations corresponding to the first associated identifier, a priority of one or more prediction parameters corresponding to the first associated identifier, or any combination thereof and the at least one set of machine learning configurations or the at least one set of prediction parameters indicated via the reporting message corresponds to the priority of the one or more channel state information report configurations, the priority of the one or more prediction parameters, or both.

In some examples of the method, UEs, and non-transitory computer-readable medium described herein, the first control message includes a respective flag for each associated identifier of the set of associated identifiers and the respective flag includes a first value indicating that a corresponding associated identifier may be associated with the first set of additional conditions or including a second value indicating that the corresponding associated identifier may be associated with the second set of additional conditions of the network entity.

In some examples of the method, UEs, and non-transitory computer-readable medium described herein, the set of associated identifiers may be indicated by the first control message in accordance with an order of respective associated identifiers and the order may be indicative of whether a respective associated identifier may be associated with the first set of additional conditions of the network entity or may be associated with the second set of additional conditions of the network entity.

Some examples of the method, UEs, and non-transitory computer-readable medium described herein may further include operations, features, means, or instructions for transmitting a message including an indication that one or more of the at least one set of machine learning configurations may be no longer applicable for one or more additional prediction operations for the prediction.

In some examples of the method, UEs, and non-transitory computer-readable medium described herein, the message may be transmitted via radio resource control signaling, via medium access control-control element signaling, via uplink control information, or any combination thereof, in accordance with the one or more of the at least one set of machine learning configurations being previously indicated as applicable.

In some examples of the method, UEs, and non-transitory computer-readable medium described herein, the indication that the one or more of the at least one set of machine learning configurations may be no longer applicable may be based on whether the one or more of the set of associated identifiers may be associated with the first set of additional conditions of the network entity or the second set of additional conditions, a priority of each of the one or more of the set of associated identifiers, whether an associated identifier corresponding to the one or more of the at least one set of machine learning configurations may be associated with a neighboring cells, or any combination thereof.

Some examples of the method, UEs, and non-transitory computer-readable medium described herein may further include operations, features, means, or instructions for obtaining a machine learning model that corresponds to at least one associated identifier of the one or more of the set of associated identifiers in accordance with the first control message indicating that the one or more of the set of associated identifiers may be associated with the first set of additional conditions.

In some examples of the method, UEs, and non-transitory computer-readable medium described herein, the set of associated identifiers may be indicated via the one or more configurations for prediction operations.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports indicating current and future associated identifiers for beam prediction in accordance with one or more aspects of the present disclosure.

FIG. 2 shows an example of a wireless communications system that supports indicating current and future associated identifiers for beam prediction in accordance with one or more aspects of the present disclosure.

FIG. 3 shows an example of a process flow that supports indicating current and future associated identifiers for beam prediction in accordance with one or more aspects of the present disclosure.

FIG. 4 shows an example of a process flow that supports indicating current and future associated identifiers for beam prediction in accordance with one or more aspects of the present disclosure.

FIGS. 5 and 6 show block diagrams of devices that support indicating current and future associated identifiers for beam prediction in accordance with one or more aspects of the present disclosure.

FIG. 7 shows a block diagram of a communications manager that supports indicating current and future associated identifiers for beam prediction in accordance with one or more aspects of the present disclosure.

FIG. 8 shows a diagram of a system including a device that supports indicating current and future associated identifiers for beam prediction in accordance with one or more aspects of the present disclosure.

FIG. 9 shows a flowchart illustrating methods that support indicating current and future associated identifiers for beam prediction in accordance with one or more aspects of the present disclosure.

### DETAILED DESCRIPTION

Some wireless communications systems may support functionality-based lifecycle management (LCM) operations or model-based (e.g., model identifier (ID)-based) LCM operations for machine learning (ML) and/or artificial intelligence (AI)-enabled processes and functions. LCM may refer to the use of AI and/or ML for operations associated with maintaining one or more wireless communication links, such as channel state information (CSI) reporting (e.g., CSI prediction), beam management operations (e.g., spatial beam prediction and/or temporal beam prediction), positioning (e.g., AI and/or ML-assisted positioning), among other examples. Functionality-based LCM operations may be associated with AI and/or ML-enabled features (e.g., AI/ML models/functionalities) enabled by configurations that are supported by a user equipment (UE). Model-based LCM operations may be associated with specific configurations and/or conditions of an AI and/or ML model supported by the UE.

In some examples, a UE may use one or more AI/ML models/functionalities to perform beam prediction. In such cases, the UE may measure respective beams that correspond to one or more reference signals (e.g., synchronization signal blocks (SSBs), channel state information-reference signals (CSI-RSs)) via a first set of resources, which may be referred to as Set B beams, during a first set of measurement occasions. Additionally, the UE may perform beam prediction (e.g., inference, assumption) for a set of beams associated with a second set of resources, which may be referred to as Set A beams, using the AI/ML model/functionality, which may be based on historical measurement results of the Set B beams. That is, the UE may use various measurements of one or more Set B beams to predict one or more Set A beams. In such cases, the UE may perform the beam prediction (e.g., temporal beam prediction, spatial beam prediction) using the AI/ML model/functionality in accordance with a set of parameters, such as a Set B beam measurement window length, a Set B beam measurement periodicity, and a prediction duration for Set A beams, among other examples. The use of the AI/ML models/functionalities may be associated with a training of the AI/ML model/functionality (e.g., based on collected or known data) and one or more inference processes by which the AI/ML model/functionality uses training to analyze additional data and make one or more predictions. In some aspects, a functionality (e.g., that is supported/used by a UE) may refer to one or more AI/ML feature groups, which may correspond to one or more capabilities of the UE. As an example, some AI/ML functionality may correspond to one or more feature groups, where each feature group may have one or more components and/or a corresponding index.

In some examples, it may be preferable to have some consistency with network-side additional conditions across both training and inference for AI/ML models/functionalities used by one or more UEs. The network-side additional conditions may include aspects related to the network that are transparent to one or more UEs and may impact generalization capabilities of the UEs. An example of such additional conditions may include a network entity codebook, as some UE-side AI/ML models/functionalities for beam prediction may not generalize well across different network entity codebooks, which may result in the need for consistency with network-side additional conditions.

In some cases, a network entity may provide one or more configurations to a UE that supports beam prediction using one or more AI/ML models/functionalities. As an example, a UE may, in accordance with a capability inquiry message (e.g., UECapabilityEnquiry) from a network entity, indicate one or more AI/ML capabilities via a capability message (e.g., UECapabilityInformation, information associated with functionality-based LCM operation, a model-based LCM operation, or both). In response, the UE may receive a control message (e.g., a first control message, a radio resource control (RRC) message, an RRCReconfiguration message) from a network entity that indicates one or multiple associated identifiers (IDs) that correspond to network-side additional conditions related to beam prediction using AI/ML models/functionalities. In such cases, the network entity may provide a configuration enabling the UE to perform UE assistance information (UAI) reporting (e.g., via OtherConfig), and the network entity may provide an indication of a set of additional conditions (e.g., network-side additional condition). In some cases, the control message may indicate one or more configurations for prediction operations (e.g., one or more inference operation configurations, one or more channel state information (CSI) configurations, such as CSI-ReportConfig for inference configuration) and/or one or more parameters associated with the prediction operations (e.g., one or multiple sets of inference-related parameters). After receiving the control message, the UE may determine applicable AI/ML models/functionalities based on the network-side additional conditions, UE-side additional conditions (e.g., internally known by the UE), and AI/ML model/functionality availability (e.g., whether an ML configuration is ready to be activated by the UE, such as for prediction operations for beam prediction), and the UE may transmit a reporting message indicating the applicable AI/ML models/functionalities.

In some cases, however, it may be desirable to enable enhanced signaling to the UE to improve the UE's ability to identify which AI/ML models/functionalities may be used for beam prediction. For example, in cases where the UE is made aware of a set of associated IDs (e.g., a list of associated IDs corresponding to one or more additional conditions), the UE may be unaware of which of the associated IDs (and additional conditions) are currently in use at the network entity and/or ready to be used by the network entity, as well as which associated IDs may be applicable to future beam prediction (or beam prediction for one or more neighboring cells). Further, after receiving the list of associated IDs, the UE may have an opportunity to obtain (e.g., download) one or more AI/ML models/functionalities (e.g., from one or more servers) to perform beam prediction. But in cases where the UE is only provided with a list of associated IDs (e.g., without differentiating whether each associated ID is current and/or will be used in the future), then UE may be unable to determine the AI/ML models/functionalities that may be prioritized for download.

In accordance with techniques described herein, a UE may receive a control message that includes a list of associated IDs, and the control message may further indicate whether each associated ID included in the list of associated ID(s) is a current or future associated ID (e.g., whether a respective associated ID represents a current or future network-side additional condition). In some aspects, the information indicating whether an associated ID is a current of future associated ID may be conveyed to the UE explicitly or implicitly. As an example, the associated IDs indicated by the control message may each be accompanied by a flag representing whether the associated IDs are related to current network-side additional conditions (e.g., a first set of additional conditions) or future network-side additional conditions (e.g., a second set of additional conditions). In another example, whether an associated ID is related to current network-side additional conditions or future network-side additional conditions may be indicated via an ordering of the associated IDs, where a first associated ID (or first quantity of associated IDs) in the list may be related to current network-side additional conditions, and the remaining associated IDs may be related to future network-side additional conditions. In any case (e.g., for both implicit and explicit indications), future associated IDs (e.g., non-current associated IDs) may be indicated with different levels of priority, which may assist the UE in prioritizing downloading the AI/ML models/functionalities related to relatively higher priority associated IDs. In some aspects, non-current associated IDs (e.g., future associated IDs) may be related to one or more neighboring cells, and the associated IDs for the neighboring cells may be indicated via a flag (e.g., having respective values indicating different information).

In some aspects, the UE may receive an indication of priority across associated ID included in the list of associated IDs. Additionally, or alternatively, the UE may receive an indication of a priority across inference configurations (e.g., across multiple CSI-ReportConfig) of one or more current associated IDs. The priority may be configured by the network entity across different associated IDs, and may be used by the UE to determine which associated ID(s) to prioritize (such as without indicating explicitly what is current associated ID, where a higher priority is implicitly assumed for a current associated ID). In some aspects, within a same associated ID, the priority may be provided to different configurations or inference-related parameters (such as in the case where there may be more than one CSI-ReportConfig or inference related parameters for a single associated ID).

Aspects of the disclosure are initially described in the context of wireless communications systems. Some aspects of the disclosure are described with reference to process flows. Aspects of the disclosure are further illustrated by and described with reference to apparatus diagrams, system diagrams, and flowcharts that relate to identifying applicable functionality for beam prediction.

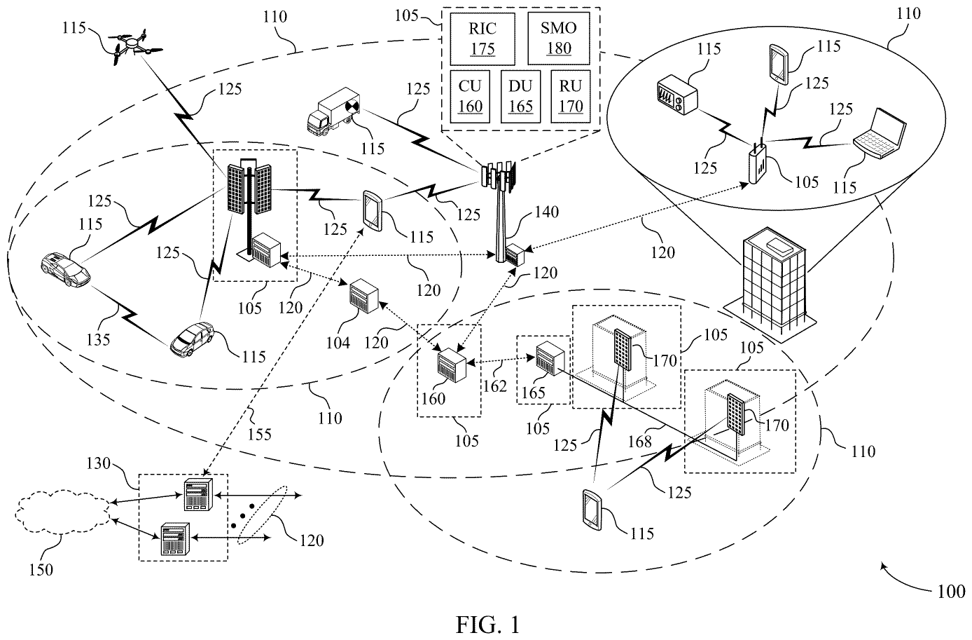

FIG. 1 shows an example of a wireless communications system 100 that supports indicating current and future associated identifiers for beam prediction in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L 3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L 1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support indicating current and future associated identifiers for beam prediction as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a UE 115 may support AI and/or ML models and/or functionalities, which the UE 115 may use to perform various wireless communications procedures (e.g., CSI prediction, beam selection, and/or beam prediction, among other examples). In such cases, the UE 115 may generate inference data using one or more AI/ML models/functionalities. Additionally, or alternatively, the UE 115 may perform LCM operations for a given AI/ML model and/or functionality (e.g., model or functionality selection, activation, deactivation, switching, and fallback, among other examples) based on one or more AI/ML models/functionalities. In some aspects, LCM may be model-based or functionality-based LCM procedures. As described herein, an AI functionality or AI model may be referred to as an ML functionality or ML model, or vice versa. That is, the terms “AI” and “ML” may, in some examples, be used interchangeably to refer to similar technologies, models, functions, algorithms, or any combination thereof. Similarly, the terms “model” and “functionality” may be used interchangeably. In some examples, ML operations may be considered a subset of AI operations. In any case, aspects of the features described herein may be referred to as AI functionalities, AI functions, AI models, AI services, AI operations, or the like, and such features may be similarly applicable to ML functionalities, ML functions, ML models, ML services, ML operations, or any combination thereof. Thus, reference to “ML” or “AI” may refer to ML, AI, or both, and the terms “AI” or “ML” should not be considered limiting to the scope of the claims or the disclosure.

A quasi co-location (QCL) relationship between one or more transmissions or signals may refer to a relationship between the antenna ports (and the corresponding signaling beams) of the respective transmissions. For example, one or more antenna ports may be implemented by a network entity 105 for transmitting at least one or more reference signals (such as a downlink reference signal, an SSB, or the like) and control information transmissions to a UE 115. However, the channel properties of signals sent via the different antenna ports may be interpreted (e.g., by a receiving device) to be the same (e.g., despite the signals being transmitted from different antenna ports), and the antenna ports (and the respective beams) may be described as being quasi co-located (QCLed). QCLed signals may enable the UE 115 to derive the properties of a first signal (e.g., delay spread, Doppler spread, frequency shift, average power) transmitted via a first antenna port from measurements made on a second signal transmitted via a second antenna port. Put another way, if two antenna ports are categorized as being QCLed in terms of, for example, delay spread then the UE 115 may determine the delay spread for one antenna port (e.g., based on a received reference signal, such as CSI-RS) and then apply the result to both antenna ports. Such techniques may avoid the UE 115 determining the delay spread separately for each antenna port. In some cases, two antenna ports may be said to be spatially QCLed, and the properties of a signal sent over a directional beam may be derived from the properties of a different signal over another, different directional beam. That is, QCL relationships may relate to beam information for respective directional beams used for communications of various signals.

Different types of QCL relationships may describe the relationship between two different signals or antenna ports. For instance, QCL-TypeA may refer to a QCL relationship between signals including Doppler shift, Doppler spread, average delay, and delay spread. QCL-TypeB may refer to a QCL relationship including Doppler shift and Doppler spread, whereas QCL-TypeC may refer to a QCL relationship including Doppler shift and average delay. A QCL-TypeD may refer to a QCL relationship of spatial parameters, which may indicate a relationship between two or more directional beams used to communicate signals. Here, the spatial parameters may indicate that a first beam used to transmit a first signal may be similar (or the same) as another beam used to transmit a second, different, signal, or, that the same receive beam may be used to receive both the first and the second signal. Thus, the beam information for various beams may be derived through receiving signals from a transmitting device, where, in some cases, the QCL information or spatial information may help a receiving device efficient identify communications beams (e.g., without having to sweep through a large quantity of beams to identify a beam (e.g., the beam having a highest signal quality)). In addition, QCL relationships may exist for both uplink and downlink transmissions and, in some cases, a QCL relationship may also be referred to as spatial relationship information.

In some examples, transmission configuration indicator (TCI) states may include one or more parameters associated with a QCL relationship between transmitted signals. For example, each TCI state includes parameters for configuring a QCL relationship between one or two downlink reference signals and the DMRS ports of PDSCH, the DMRS port of PDCCH or the CSI-RS port(s) of a CSI-RS resource. The QCL relationship is configured by a first higher layer parameter for the first downlink reference signal, and by a second higher layer parameter for the second downlink reference signal (if configured). That is, a network entity 105 may configure a QCL relationship that provides a mapping between a reference signal and antenna ports of another signal, and the TCI state may be indicated to the UE 115 by the network entity 105. In some cases, a set of TCI states (e.g., a list of TCI states) may be indicated to a UE 115 via RRC signaling, where some quantity of TCI states may be configured via RRC and one or more TCI states may be indicated (e.g., activated) via a medium access control (MAC)-control element (MAC-CE), and further indicated via DCI (e.g., within a CORESET). The QCL relationship associated with the TCI state (and further established through higher-layer parameters) may provide the UE 115 with the QCL relationship for respective antenna ports and reference signals transmitted by the network entity 105.

Wireless communications system 100 may support functionality-based LCM operations or model-based (e.g., model ID-based) LCM operations for ML and/or AI-enabled processes and functions. LCM may refer to the use of AI and/or ML for operations that maintain one or more wireless communication links, such as CSI reporting (e.g., CSI prediction), beam management operations (e.g., spatial and temporal beam prediction), positioning (e.g., AI and/or ML-assisted positioning), among other examples. Functionality-based LCM operations may be associated with AI and/or ML-enabled features (e.g., ML functionalities) enabled by configurations that are supported by a UE 115. Model-based LCM operations may be associated with specific configurations or conditions of an AI and/or ML model supported by the UE 115. In some examples, the UE 115 may indicate its support for a functionality-based LCM operation, a model-based LCM operation, or both. For example, the UE 115 may transmit UE assistance information (UAI) or other signaling indicating an applicability of particular ML functions or ML models.

The wireless communications system 100 may support techniques for indicating whether one or more associated IDs correspond to a first set of additional conditions, which may be referred to as current network-side additional conditions (e.g., currently-configured additional conditions, additional conditions that are applicable or are ready to be applied) or whether the one or more associated IDs correspond to a second set of additional conditions, which may be referred to as future network-side additional conditions (e.g., additional conditions that may be configured and/or applied at some later time) for prediction operations (e.g., beam prediction operations, among other examples). For example, a UE 115 may receive, from a network entity 105, a control message that indicates a list of associated IDs. The control message may further indicate whether each associated ID included in the list of associated ID(s) is a current or future associated ID (e.g., whether a respective associated ID represents a current or future network-side additional condition). In some examples, the control message may indicate one or more configurations for beam prediction (e.g., one or more CSI-ReportConfig) and/or one or more inference-related parameters for beam prediction. In some examples, the list of associated IDs may be included within (e.g., signaled via) the one or more configurations for beam prediction (e.g., prediction operations). The information indicating whether an associated ID is a current of future associated ID may be conveyed to the UE 115 explicitly or implicitly. As an example, the associated IDs indicated by the control message may each be accompanied by a flag representing whether the associated IDs are related to current network-side additional conditions or future network-side additional conditions. In another example, whether an associated ID is related to current network-side additional conditions or future network-side additional conditions may be indicated via an ordering of the associated IDs, where a first associated ID (or first quantity of associated IDs) in the list may be related to current additional conditions, and the remaining associated IDs may be related to future additional conditions. In any case (e.g., for both implicit and explicit indications), future associated IDs (e.g., non-current associated IDs) may be indicated with different levels of priority, which may assist the UE 115 in prioritizing downloading the AI/ML models/functionalities related to relatively higher priority associated IDs. In some aspects, non-current associated IDs (e.g., future associated IDs) may be related to one or more neighboring cells, and the associated IDs for the neighboring cells (e.g., provided by one or more network entities 105) may be indicated, for example, via a flag or some other indication.

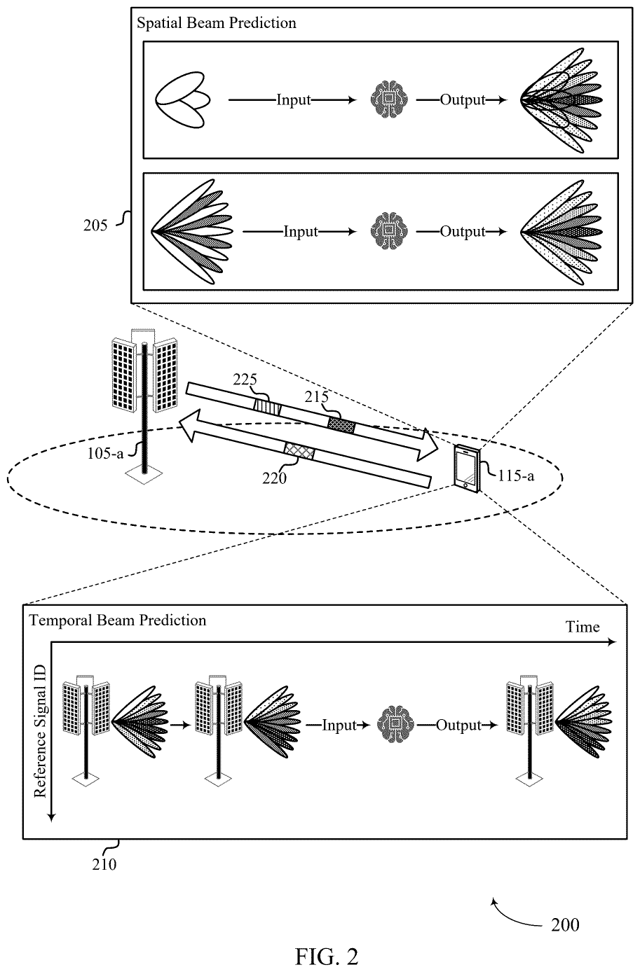

FIG. 2 shows an example of a wireless communications system 200 that supports indicating current and future associated identifiers for beam prediction in accordance with one or more aspects of the present disclosure. In some examples, the wireless communications system 200 may implement aspects of the wireless communications system 100 or may be implemented by aspects of the wireless communications system 100. For example, the wireless communications system 200 may include a UE 115-a and a source network entity 105-a, which may be examples of corresponding devices described herein. In some examples, the UE 115-a and the network entity 105-a may support one or more ML functionalities or ML models for a functionality or model-based LCM operation. In some aspects, the wireless communications system 200 may support indications of whether associated IDs relate to current or non-current (e.g., future) network-side additional conditions.

Wireless communications system 200 may support functionality-based LCM operations or model-based (e.g., model ID-based) LCM operations for ML and/or AI-enabled processes and functions. LCM may refer to the use of AI and/or ML for operations that maintain one or more wireless communication links, such as CSI reporting (e.g., CSI prediction), beam management operations (e.g., spatial beam prediction 205 and/or temporal beam prediction 210), positioning (e.g., AI and/or ML-assisted positioning), among other examples. Functionality-based LCM operations may be associated with AI and/or ML-enabled features (e.g., AI/ML models/functionalities) enabled by configurations that are supported by a UE 115-a. Model-based LCM operations may be associated with specific configurations or conditions of an AI and/or ML model supported by the UE 115-a.

In some examples, the UE 115-a may use one or more AI/ML models/functionalities to perform beam prediction. In such cases, the UE 115-a may measure respective beams that correspond to one or more reference signals (e.g., SSBs, CSI-RSs) via a first set of resources, which may be referred to as Set B beams, during a first set of measurement occasions. Additionally, the UE 115-a may perform beam prediction (e.g., inference, assumption) for a set of beams associated with a second set of resources, which may be referred to as Set A beams, using the AI/ML model/functionality, which may be based on historical measurement results of the Set B beams. That is, the UE 115-a may use various measurements of Set B beams to predict one or more Set A beams. In such cases, the UE 115-a may perform the beam prediction (e.g., temporal beam prediction 210, spatial beam prediction 205) using the AI/ML model/functionality in accordance with a set of parameters, including a Set B beam measurement window length, a Set B beam measurement periodicity, and a prediction duration for Set A beams, among other examples. The use of the AI/ML models/functionalities may be associated with a training of the AI/ML model/functionality (e.g., based on collected or known data) and one or more inference processes by which the AI/ML model/functionality uses training to analyze additional data and make one or more predictions. In accordance with the temporal beam prediction 210, a network entity 105 and/or a UE 115 may measure a set of one or more reference signals (e.g., CSI-RSs, SSBs) to obtain one or more measurements associated with the one or more reference signals (e.g., reference signal received power (RSRP) measurements). The network entity 105 and/or a UE 115 may input a time series of the one or more reference signal measurements (e.g., time series of L1-RSRPs) into an AI/ML model. The AI/ML model may output a set of predicted beams according to a temporal domain. In such examples, the predicted beams may correspond to a set of beam that are the same as a measured set of beam but are transmitted later in time.

In some examples, the UE 115-a and/or network entity 105-a may support one or more enhancements related to AI/ML inference procedures. For example, the UE 115-a and/or network entity 105-a may support reporting enhancements for carrying spatial and/or temporal beam prediction results. Additionally, or alternatively, the UE 115-a and/or network entity 105-a may support Set A/Set B configurations for reporting of inference results. The UE 115-a and/or network entity 105-a may support one or more enhancements related to AI/ML performance monitoring. For example, the UE 115-a and/or network entity 105-a may support network-side performance monitoring and/or UE-assisted performance monitoring.

In some examples, there may need to be some consistency with network-side additional conditions across both training and inference for AI/ML models/functionalities used by one or more UEs 115. The network-side additional conditions may include aspects related to the network that are transparent to one or more UEs 115 and may impact generalization capabilities of the UEs 115. An example of such additional conditions may include a network entity codebook, as some UE-side AI/ML models/functionalities for beam prediction may not generalize well across different network entity codebooks. That is, as described herein, “additional conditions” and “network-side additional conditions” may refer to one or more aspects related to beamforming and/or beam prediction, such as a codebook, and which may be transparent to a UE 115. In some aspects, the “additional conditions” may be referred to as conditions or some other terminology. Consistency with network-side additional conditions may be needed to enable efficient communications between the UE 115-a and the network entity.

In some examples, various techniques may be used to support the consistency of network-side additional conditions across training and inference for UE-sided models for beam management (BM)-Case 1 and BM Case 2, where the network-side additional conditions may at least impact UE assumptions on beams of Set A/Set B. In some examples, the techniques may be based on an associated ID, where some information may be assumed by UE 115-a with the same associated ID across training and inference. An “associated ID” may refer to some identifier that is indicative of one or more beam parameters (e.g., beam shapes, beam pointing angles, or other aspects and/or parameters associated with beamforming). The associated ID may, in some examples, be referred to as a data set ID, a data configuration ID, or some similar terminology. In some cases, different infrastructure vendors may use different associated IDs for different beam parameters, which may present challenges for a UE to determine the beam parameters across different vendors. In other examples, the associated IDs may be the same across some vendors. In any case, the UE 115-a may benefit from receiving additional information (e.g., supplemental information) corresponding to an associated ID to help determine information about relevant beams used, for example, for beam prediction. For instance, the UE 115-a may have one or more AI/ML models/functionalities that are trained using a set of associated IDs (e.g., for beam prediction or other operations). As such, for prediction operations, it may be important for the UE 115-a to know whether an indicated associated ID corresponds to one of the associated IDs used to train an AI/ML model. That is, the UE 115-a may determine that it may use a particular AI/ML model/functionality that was trained using a same (or similar) associated ID that was indicated to the UE 115 for beam prediction operations. In some examples, the associated ID may be used, for example, within a CSI framework or outside of the CSI framework, among other examples. In some cases, the techniques for performance monitoring may be based on other schemes or parameters.

Thus, for a UE-sided model in beam management, the associated ID may be supported. In such cases, the associated ID may at least be configured within a CSI framework. In some aspects, various techniques may be used for configuring/indicating the associated ID via one or more signal(s) and/or in other procedure(s)/framework(s), which may correspond to whether/how the associated ID is configured/indicated using such techniques. In some examples, the UE 115-a may assume similar properties of a downlink transmission beam or beam set/list associated with the same associated ID, where the similar properties of the downlink transmission beam or beam set/list may be defined in some way.

To support AI/ML functionality and/or model-based LCM operations, applicability information associated with AI/ML functionalities and models may be provided to a network entity 105-a. The applicability information may indicate whether AI/ML functionalities or AI/ML models, or a combination thereof, are applicable to the UE 115-a (e.g., supported by the UE 115-a, usable by the UE 115-a). In some cases, the network entity 105-a may provide configurations to the UE 115-a for reporting functionality and model applicability information. For example, the network entity 105-a may transmit or output a message (e.g., a control message) indicating a configuration for reporting applicability information associated with AI/ML functionalities and models for maintaining AI/ML-based operations. The applicability information may indicate an applicability of one or more ML functionalities (e.g., AI functionalities) or one or more ML models (e.g., AI models) supported. That is, the applicability information may indicate whether the UE 115-a supports and/or uses the one or more AI/ML functionalities or the one or more AI/ML models for one or more cells, in a RAN notification area, in a target area, or the like. In some examples, the UE 115-a may report the applicability information via UAI, via a measurement report, or via some other signaling.

As described herein, supported functionalities may refer to one or more functionalities (e.g., AI/ML functionalities and/or models) that the UE 115-a can indicate by using UE capability information (via RRC/LPP signaling), and applicable functionalities (e.g., activatable functionalities) may refer to one or more functionalities (e.g., AI/ML functionalities and/or models) that the UE 115-a is ready to apply for inference (where an applicable functionality may be included in the supported functionalities). Further, activated functionalities (e.g., AI/ML functionalities and/or models) may refer to functionalities already enabled for performing inference. A “functionality” may refer to one or more feature groups that correspond to capabilities (e.g., UE capabilities). As an example, for a first functionality or sub-functionality (e.g., corresponding to a first use case), there may be a first features group that corresponds to, for example, temporal beam prediction (e.g., predicting a set of beams from prior measurements of a set of beams). Further, for a second functionality or sub-functionality (e.g., corresponding to a second use case), there may be a second feature group that correspond to, for example, spatial beam prediction (e.g., predicting relatively narrow beams from relatively wide beams). In some examples, the first feature group and the second feature group may be different.

In some cases, the network entity 105-a may provide one or more configurations to a UE 115 that supports beam prediction using one or more AI/ML models/functionalities. As an example, the UE 115-a may, in accordance with a capability inquiry message (e.g., UECapabilityEnquiry) from a network entity, indicate one or more AI/ML capabilities via a capability message (e.g., UECapabilityInformation, information associated with functionality-based LCM operation, a model-based LCM operation, or both). In response, the UE 115-a may receive a control message 215 (e.g., a first control message, an RRC message, an RRCReconfiguration message) from the network entity 105-a that indicates one or multiple associated IDs that correspond to network-side additional conditions related to beam prediction using AI/ML models/functionalities. In such cases, the network entity 105-a may provide a configuration enabling the UE 115-a to perform UAI reporting procedures (e.g., via OtherConfig), and the network entity 105-a may provide an indication of a set of additional conditions (e.g., network-side additional condition). In some cases, the control message may indicate one or more configurations for prediction operations (e.g., one or more CSI configurations, such as CSI-ReportConfig for inference configuration) and/or one or more parameters associated with the prediction operations (e.g., one or multiple sets of inference-related parameters). After receiving the control message, the UE 115-a may determine applicable AI/ML models/functionalities based on the network-side additional conditions, UE-side additional conditions (e.g., internally known by the UE 115-a), and AI/ML model/functionality availability (e.g., whether an ML configuration is ready to be activated by the UE 115-a, such as for prediction operations for beam prediction), and the UE 115-a may transmit a reporting message 220 indicating the applicable AI/ML models/functionalities.

In some cases, however, it may be desirable to enable enhanced signaling to the UE 115-a to improve the techniques for the identification of which AI/ML models/functionalities may be used for beam prediction. For example, in cases where the UE 115-a is made aware of a set of associated IDs (e.g., a list of associated IDs corresponding to one or more additional conditions), the UE 115-a may be unaware of which of the associated IDs (and additional conditions) are currently in use at the network entity 105-a and/or ready to be used by the network entity 105-a, as well as which associated IDs may be applicable to future beam prediction (or beam prediction for one or more neighboring cells). Further, after receiving the list of associated IDs, the UE 115-a may have an opportunity to obtain (e.g., download) one or more AI/ML models/functionalities (e.g., from one or more servers) to perform beam prediction. But in cases where the UE 115-a is only provided with a list of associated IDs (e.g., without differentiating whether each associated ID is current and/or will be used in the future), then UE 115-a may be unable to determine the AI/ML models/functionalities that may be prioritized for download.

In accordance with techniques described herein, the wireless communications system 200 may support techniques for indicating whether one or more associated IDs correspond to current network-side additional conditions (e.g., currently-configured additional conditions, additional conditions that are ready to be applied) or future network-side additional conditions (e.g., additional conditions that may be configured and/or applied at some later time) for beam prediction operations. As described herein, a “current” network-side associated ID may refer to an existing network-side additional condition for which the network entity 105-a is ready to activate a corresponding configuration (e.g., via a control message 225). A “future” network-side additional condition may refer to cases where a configuration corresponding to one or more future associated IDs may not be intended to be immediately activated, but include the set(s) of associated IDs that the network entity 105-a supports and may activate the related configurations at a later time (e.g., based on one or more applicability reports from UE 115-a). As an example, the network entity 105-a may share one or more associated IDs (e.g., one or more candidate associated IDs) and may provide an indication to the UE 115-a about which associated ID(s) are representative of current (e.g., currently implemented) network-side additional conditions (e.g., for which the network entity 105-a is ready to activate a corresponding functionality, which may be based on one or more UE reports of applicability of functionality), and which associated ID(s) may be related to network-side additional conditions that the network entity 105-a may wait to activate (e.g., that the network entity 105-a may determine to not activate immediately and/or in accordance with some delay or duration). As such, the network entity 105-a may notify the UE 115-a about the candidate associated IDs before activation, because those associated IDs are supported by the network entity 105-a. Thus, reference to “future” associated IDs and/or “future” additional conditions may refer to some associated IDs and/or additional conditions that may be ready to activate/use at some later time. In some examples, the network entity 105-a may indicate, to the UE 115-a, one or more associated IDs (e.g., existing associated IDs) of one or more neighboring cells. Such associated IDs (and additional conditions or inference configuration(s), or both) may be activated at some time in the future (e.g., at some time after the indication is provided to the UE 115-a), and may accordingly be referred to as “future associated IDs” and/or “future associated conditions,” or some other similar terminology.

The UE 115-a may receive a control message 215 that includes a list of associated IDs, and the control message 215 may further indicate whether each associated ID included in the list of associated ID(s) is a current or future associated ID (e.g., whether a respective associated ID represents a current or future network-side additional condition). In some aspects, the information indicating whether an associated ID is a current of future associated ID may be conveyed to the UE 115-a explicitly or implicitly. As an example, the associated IDs indicated by the control message 215 may each be accompanied by a flag representing whether the associated IDs are related to current or future network-side additional conditions. In another example, whether an associated ID is related to current or future network-side additional conditions may be indicated via an ordering of the associated IDs, where a first associated ID (or first quantity of associated IDs) in the list may be related to current additional conditions, and the remaining associated IDs may be related to future additional conditions. In any case (e.g., for both implicit and explicit indications), future associated IDs (e.g., non-current associated IDs) may be indicated with different levels of priority, which may assist the UE in prioritizing downloading the AI/ML models/functionalities related to relatively higher priority associated IDs. In some aspects, non-current associated IDs (e.g., future associated IDs) may be related to one or more neighboring cells, and the associated IDs for the neighboring cells may be indicated via a flag.

In some aspects, the UE 115-a may receive an indication of priority across associated IDs included in the list of associated IDs. Additionally, or alternatively, the UE 115-a may receive an indication of a priority across inference configurations (e.g., across multiple CSI-ReportConfig) of one or more current associated IDs. The priority may be configured by the network entity across different associated IDs, and may be used by the UE 115-a to determine which associated ID(s) to prioritize (such as without indicating explicitly what is current associated ID, where a higher priority is implicitly assumed for a current associated ID). In some aspects, within a same associated ID, the priority may be provided to different configurations or inference-related parameters (such as in the case where there may be more than one CSI-ReportConfig or inference related parameters for a single associated ID).

In some examples, the indication of whether the associated ID(s) are current or future associated IDs may be included in signaling that the UE 115-a is allowed to perform UAI reporting and may be transmitted via an information element (such as OtherConfig). In some aspects, the control message 215 may be transmitted via RRC signaling (e.g., via RRCReconfiguration or other RRC messages (such as RRC setup or RRC resume)). Additionally, or alternatively, the indication of whether the associated ID(s) are current or future associated IDs may be signaled via one or more configurations (e.g., CSI-ReportConfig). In some examples, if an associated ID is signaled within the configuration (such as the CSI-ReportConfig), multiple configurations (e.g., multiple CSI-ReportConfigs) may be indicated by the network entity 105-a to the UE 115-a, and the indication of whether the associated ID(s) are current or future associated IDs (which may be explicit and/or implicit), as described herein, may be applicable for the list of CSI-ReportConfigs. As described herein, an AI/ML configuration for prediction (e.g., for inference, for beam prediction) may refer to a CSI report configuration or other configuration. In some other examples, if an associated ID is not included within the configuration (e.g., CSI-ReportConfig), various aspects described herein may be used for CSI report configurations, such as the indication of current and future configurations via an explicit or implicit manner to the UE 115-a.

In some aspects, the UE 115-a may report to the network entity 105-a when an applicable AI/ML model/functionality becomes non-applicable. That is, an AI/ML model/functionality may have been previously reported as being applicable, but the same AI/ML model/functionality may no longer be applicable, and the UE 115-a may transmit a report, to the network entity 105-a, indicating that the AI/ML model/functionality is no longer applicable (e.g., non-applicable). In some examples, when a configured CSI report configuration (e.g., a configured AI/ML model/functionality for beam inference) becomes non-applicable, the UE 115-a may indicate the non-applicable CSI-report configuration using RRC, MAC-CE or UCI. A configured but non-applicable CSI report configuration may not be activated by using RRC, MAC-CE, or DCI. In some cases, a CSI report configuration for one or more neighboring cells or more than one (not current) associated IDs may be provided to the UE 115-a. In such cases, if one or more CSI report configurations are for at least one neighboring cell or more than one (no longer current) associated IDs, when the CSI report configuration becomes non-applicable, an indication of the non-applicability of a configuration may be transmitted via RRC signaling. In some aspects, such as for neighboring cells, an indication that a configuration is non-applicable (no longer applicable, when it was previously indicated as applicable) may be sent from a source cell to one or more neighboring cells. That is, when one or more CSI report configurations corresponding to one or more associated IDs become non-applicable (that was previously reported as applicable), then the UE 115-a may indicate the non-applicability via RRC, MAC-CE, or UCI. In some examples, the indication of non-applicability from the UE 115-a is based on: whether associated ID is current/non-current, based on a priority of associated IDs, or whether the associated ID is from the neighboring cells versus serving cell. In other words, the UE 115-a may prioritize the non-applicability reporting (reports sooner) based, at least in part, on some notion of priority for the associated IDs or corresponding configurations, as discussed herein.

Particular aspects of the subject matter described in this disclosure may be implemented to realize one or more of the following potential advantages. For example, the described techniques for indicating of current and non-current (e.g., future) associated IDs may provide one or more improvements to information sharing between the network entity 105-a and the UE 115-a, which may enable efficient communication and other operations. As an example, if the UE 115-a is made aware of the current associated ID (e.g., representing current network-side additional conditions), then the UE 115-a may prioritize responding to applicable CSI report configuration(s) and/or inference-related parameters. In some aspects, the appropriate AI/ML model/functionality may already be available at the UE 115-a and, if not, the UE 115-a may obtain (e.g., download) the appropriate AI/ML model/functionality. In some examples, the UE 115-a may notify the network entity 105-a of an expected time in which the model may be available at the UE 115-a for inference. In some examples, if the UE 115-a is made aware of future associated IDs for the network entity 105-a, then the UE 115-a may obtain (e.g., download) the models related to those associated IDs (where the UE 115-a may optionally consider a priority (an indicated priority) of the associated IDs). The UE 115-a may also indicate, to the network entity 105-a, an expected time in which each of the future associated IDs (e.g., plus inference configuration/inference-related parameters) may be available at the UE 115-a. Once the UE 115-a downloads the appropriate model(s), the UE 115-a may indicate, to the network entity 105-a, the availability of the model at the UE 115-a for each associated ID (e.g., plus inference configuration(s) and/or one or more inference-related parameters). In accordance with the described techniques, after receiving the applicability information for a given associated ID (plus inference configuration/inference related parameters), the network entity 105-a may not need to repeat a transmission of the associated IDs for one or more future associated IDs (e.g., which were previously indicated, and which would entail the latency associated with RRC reconfiguration and UE downloading the appropriate model), and the network entity 105-a may activate (e.g., immediately activate) the corresponding AI/ML model/functionality (e.g., via a control message 225). Thus, in cases where the UE 115-a is only provided with a list of associated IDs without differentiating whether the associated ID is current versus future, then UE 115-a may be unable to determine which model (associated with which associated IDs) may be prioritized for download, and the described techniques accordingly provide one or more solutions to such challenges.

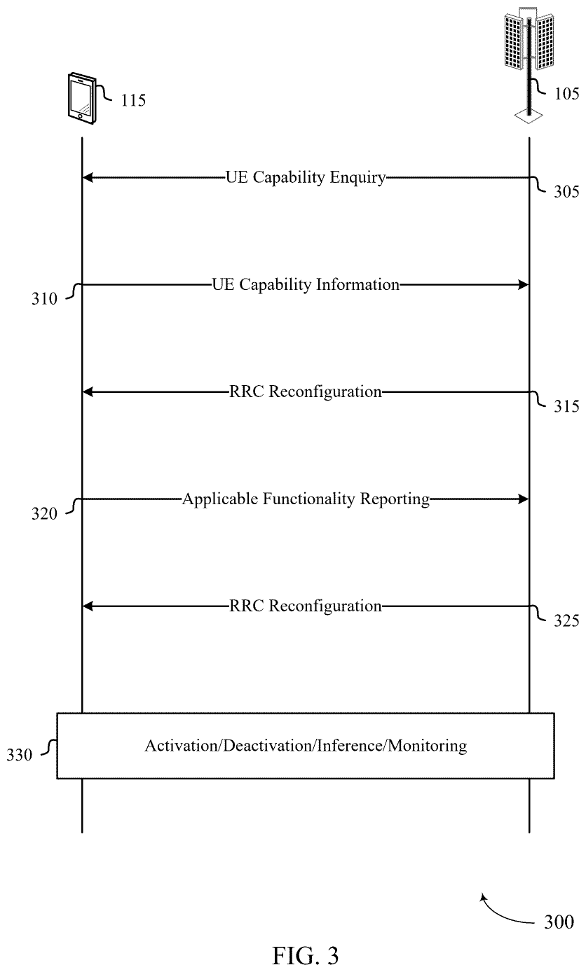

FIG. 3 shows an example of a process flow 300 that supports indicating current and future associated identifiers for beam prediction in accordance with one or more aspects of the present disclosure. The process flow 300 may implement aspects of wireless communications system 200, or may be implemented by aspects of the wireless communications systems 100 and 200. For example, the process flow 300 may illustrate operations between a UE 115 and network entity 105, which may be examples of corresponding devices described herein. In the following description of the process flow 300, the operations between the UE 115 and the network entity may be transmitted in a different order than the example order shown, or the operations performed by the UE 115 and network entity may be performed in different orders or at different times. Some operations may also be omitted from the process flow 300, and other operations may be added to the process flow 300. The process flow 300 may be an example of a signaling procedure for applicable functionality reporting for beam management using UE-sided model(s).

At 305, the UE 115 may receive a capability enquiry (e.g., a message including UECapabilityEnquiry) requesting AI/ML-related capabilities. As an example, the network entity 105 may request information regarding AI/ML capabilities of the UE 115 (e.g., what the UE 115 is capable of performing using AI/ML).

At 310, the UE 115 may transmit capability information (e.g., a message including UECapabilityInformation). Here, the UE 115 may provide the UE capability parameters associated with one or more feature groups for AI/ML operations/functions. In some cases, the UE 115 may indicate a set of feature groups and/or a set of parameters within each feature group (e.g., within each functionality). In some examples, capabilities exchanged at 305 and at 310 may be considered “static” information that remains relatively fixed after UE deployment, while associated IDs and functionalities may be considered “variable” information that may change over time. The distinction between “static” and “variable” information may be, for example, due to AI/ML model training being ongoing even after a UE 115 is released to market, resulting in dynamic availability of associated IDs and functionalities. As such, in some cases, the exchange of supported associated IDs, functionalities, or both, may not occur during the initial capability exchange steps (e.g., at 305 and at 310), but rather during later configuration and applicability reporting phases of the procedure (e.g., at 315, at 320, at 325, and/or at 330).

At 315, the associated ID corresponding to the current network-side additional condition as well as the CSI-ReportConfig that may be used for the purpose of enabling inference operation for beam prediction, may be transmitted from the network entity 105 (e.g., from the network) to the UE 115. In some cases, at 315, one or more configurations may be provided from the network entity 105 to the UE 115, which may include: 1) the UE 115 is allowed to perform UAI reporting via OtherConfig, 2) the network entity 105 may provide network-side additional conditions (which may be signaled via RRC signaling, and may be mandatory or optional), and/or 3) one or more configurations (e.g., inference configurations) of supported functionalities.

In some cases, at 315, the network entity 105 may provide one or more configurations to the UE 115, which may include enabling the UE 115 to perform UAI reporting via OtherConfig. The applicability report may be based on one or more options (e.g., option A, option B, or both), and the design of the container may be determined by the network entity 105. For option A, the network entity 105 may configure one or more CSI-ReportConfig for inference configuration, and the associated ID may be configured in a CSI framework according to one or more device specifications (e.g., as a working assumption). In some implementations, the CSI report configuration for UE-side model inference may not be activated immediately upon receiving the signaling at 315.

Additionally, or alternatively, at 315, for option B, the network entity 105 may configure one set or multiple sets of inference related parameters for an applicability report (e.g., not for inference). The design of the container may be determined by the network entity 105. The set of inference related parameters may be selected from the information elements (IEs) in or the IEs referred by CSI-ReportConfig as a starting point. The inference related parameters may include one or more of the associated ID (though this may not imply the associated ID is mandatory), Set A related information, Set B related information, report content related information, and for BM-Case 2, time instances related information for measurements and time instances related information for prediction. In some cases, for option B of an applicability check, the network entity 105 may assume that a set of RRC parameters are to be reused. The set of RRC parameters may include associatedIDforSetA-r19, resourcesForSetA-r19, resourcesForChannelMeasurement, associatedIDforSetB-r19, reportQuantity-r19, reportConfigType, nrofreportedpredictedrs-r19, or any combination thereof (for BM-Case 1 and BM-Case 2), and may further include TimeGap-r19, nroftimeinstance-r19 (for BM-Case 2). In any case, the set of RRC parameters may exclude one or more associated IDs in some examples.

In some examples, after 315 (e.g., and before 320), the UE 115 may determine (e.g., identify, select) the applicable functionalities based on the network-side additional conditions (e.g., if provided), one or more UE-side additional conditions (e.g., internally known by the UE 115), and/or model availability in the device. In some examples one or more other configurations may be considered by the UE 115 (e.g., inference configuration), and the UE 115 may, in some cases, be capable of determining the applicable functionality when network-side additional condition are not provided at 315.

At 320, the UE 115 may report applicable functionality. In some examples, the applicable functionality may be reported in the following scenarios: 1) upon being configured to provide applicable functionality and after change of applicable functionality via UAI and/or 2) as response to network-side additional condition requesting applicable functionality reporting at 315. In some implementations, the UE 115 may report applicability for option A (one or more CSI-ReportConfig parameters) and/or option B (one or more sets of inference related parameters) configurations provided at 315. The UE 115 may determine whether other information along with the applicability may be provided. If option A is configured at 315, an applicable aperiodic CSI Report and a semi-persistent CSI report may be activated or triggered by the network entity 105 after the applicability is reported. Applicable periodic CSI Report may be considered as activated if the applicability of the corresponding CSI-ReportConfig is reported in RRCReconfigurationComplete.

At 325, the network entity 105 may configure one or more inference configurations for the UE 115 after the applicable functionality reporting, such as in cases where an inference configuration based on supported functionality is not provided at 315 (i.e., inference configuration is provided at 325). Additionally, or alternatively, at 325, if one or more inference configurations based on supported functionality are provided at 315, it may be up to network implementation as to whether to provide an updated configuration. In some implementations, the network entity 105 may optionally configure CSI-ReportConfig for inference configuration in RRCReconfiguration, and the associated ID may be configured in a CSI framework according to one or more wireless communication specifications (e.g., as an applied working assumption). In some cases, this configuration of CSI-ReportConfig may be optional if the UE 115 has already been configured with CSI-ReportConfig at 315.

At 330, one or more AI/ML models/functionalities may be activated or deactivated, and/or the UE 115 and/or network entity 105 may perform inference using the AI/ML models/functionalities. Additionally, or alternatively, the UE 115 and/or the network entity 105 may perform monitoring procedures.

In some examples, there may be various options associated with the signaling of applicability for inference in accordance with a UE-side model for beam prediction. For instance, in accordance with a first option, at 315 one or more of the following configurations may be provided from the network entity 105 to the UE 115:
1) UE is allowed to do UAI reporting via OtherConfig, 2)+3) the network entity 105 configures one or more CSI-ReportConfig for inference configuration, where the associated ID may be configured in a CSI framework. In some examples, associated IDs may be included within one or more configurations for prediction operations. In some cases, some IEs in the CSI report configuration may be removed or modified. In some examples, a CSI report configuration for UE-side model inference may not be activated immediately after receiving signaling from the network at 315. Further, in accordance with the first option, at 320, the UE 115 may report applicability(ies) of the indicated CSI-ReportConfig. In some examples, one or more of the indicated CSI-ReportConfig may be reported. In some examples, one or more inference reports may be activated after obtaining the applicability from the UE 115 at 320. In some cases, operations described at 325 may be optional.

As another example, and in accordance with a second option, at 315, one or more of the following configurations may be provided from the network entity to the UE 115: UE is allowed to do UAI reporting via OtherConfig, the network configures one set or multiple sets of inference related parameters, and the associated IDs may be configured. In some examples, the set of inference related parameters may not be configured via CSI-ReportConfig. In some examples, the set of inference related parameters, may include Set A related information, Set B related information, Report content related information, information associated with BM-Case 2 (such as time instances related information for measurements and/or time instances related information for prediction), or any combination thereof. In some cases, the associated ID(s) indicated at 315 may be part of one set of the inference related parameters, or independent from the one set of the inference related parameters. Further, and in accordance with the second option, at 320, the UE 115 may report applicability of the one or multiple sets of inference related parameters, where the associated ID information may be associated with the parameters, and at 325, the network entity 105 may configure one or more configurations for CSI reporting for inference (e.g., beam prediction operations).

In some examples, and in accordance with a third option, at 315, one or more of the following configurations may be provided from the network entity 105 to the UE 115: 1) UE is allowed to do UAI reporting via OtherConfig, 2) The associated ID(s) may be provided to UE, e.g., a new RRC parameter. With the third option, at 320, the UE 115 may report, via UAI, applicability of one or multiple sets of inference related parameters and/or the associated ID(s) (which may be included, for example, as part of the inference related parameters, or independent from the set of the inference related parameters). In some examples, the set of inference related parameters, may include at least one or more of: Set A related information, Set B related information, report content related information, information associated with BM-Case 2 (such as time instances related information for measurements, time instances related information for prediction), or any combination thereof. In some examples, the UE 115 may further provide an indication of one or more functionalities/configurations that are no longer applicable. In some examples, if the inference related parameters may not be supported for reporting, only the indication applicability(ies) or indication of not-applicable may be reported at 320. In accordance with the third option, at 325, the network entity 105 may configure one or more configurations for CSI report for inference (e.g., beam prediction operations).

In some examples, one or more of the options (e.g., the first option, the second option, the third option), or portions thereof, may be implemented for a UE-side model associated with beam prediction and inference. In some examples, there may not be an impact of configuring CSI report configuration for non-AI beam management via an RRCReconfiguration message. In some examples, the UE 115 may report to the network when an applicable AI/ML model/functionality becomes non-applicable, which may be signaled explicitly and/or implicitly, where the AI/ML model/functionality may be regarding an active functionality. In some examples, UAI may be supported and an RRCReconfigurationComplete message may be used to report applicable functionality. In some examples, data collection initiation and configuration for data collection may be controlled by the network, and the network may determine whether data collection is be initiated may be based on various parameters (e.g., via UE requests (UE directly or UE server)).

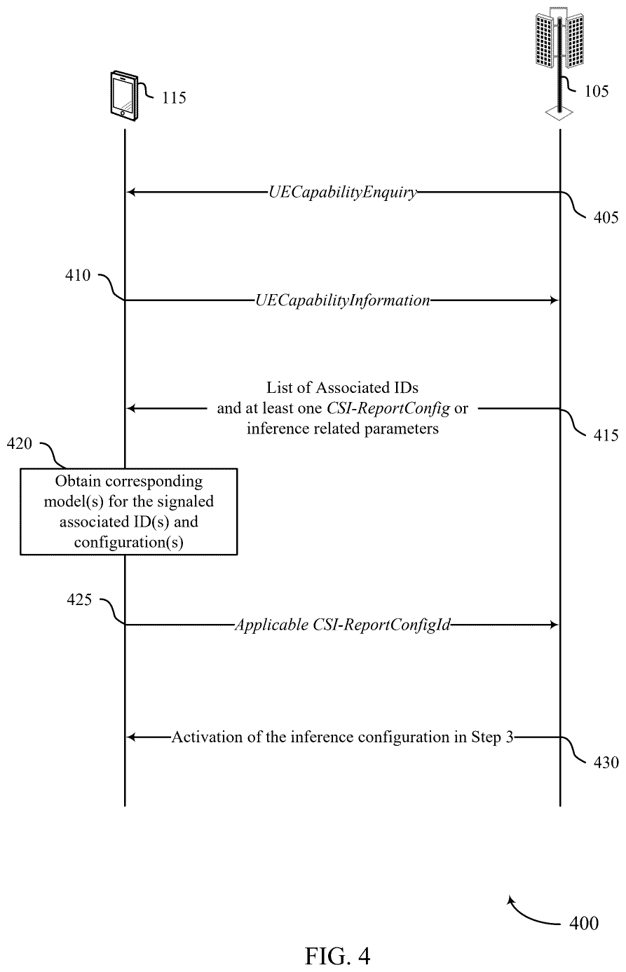

FIG. 4 shows an example of a process flow 400 that supports indicating current and future associated identifiers for beam prediction in accordance with one or more aspects of the present disclosure. The process flow 400 may implement aspects of the process flow 300, or may be implemented by aspects of the wireless communications systems 100 and 200. For example, the process flow 400 may illustrate operations between a UE 115 and network entity 105, which may be examples of corresponding devices described herein. In the following description of the process flow 400, the operations between the UE 115 and the network entity may be transmitted in a different order than the example order shown, or the operations performed by the UE 115 and network entity may be performed in different orders or at different times. Some operations may also be omitted from the process flow 400, and other operations may be added to the process flow 400. The process flow 400 may be an example of a signaling procedure for applicable functionality reporting for beam management using UE-sided model(s).

The process flow 400 may support the indication of a list of associated IDs from the network entity 105 to the UE 115. As an example, based on the three options for determining applicability for inference for UE-sided models as described with reference to FIG. 3, the content of different signals between the UE and network may be different, and signaling may be provided to the UE that indicates the associated IDs and additional information corresponding to the associated IDs, such as whether an associated ID is a future or current associated ID.

At 405, the network entity 105 may transmit, and the UE 115 may receive, a capability enquiry (e.g., a message including UECapabilityEnquiry) requesting AI/ML-related capabilities. As an example, the network entity 105 may request information regarding AI/ML capabilities of the UE 115 (e.g., what the UE 115 is capable of performing using AI/ML).

At 410, the UE 115 may transmit, and the network entity 105 may receive, capability information (e.g., a message including UECapabilityInformation). Here, the UE 115 may provide the UE capability parameters associated with one or more feature groups for AI/ML operations/functions. In some cases, the UE 115 may indicate a set of feature groups and/or a set of parameters within each feature group (e.g., within each functionality).

At 415, the network entity 105 may transmit, and the UE 115 may receive a control message indicating a set of associated identifiers, one or more configurations for prediction operations (e.g., configuration(s) for inference operations, CSI report configurations) or one or more parameters associated with the prediction operations (e.g., prediction-related parameters, inference-related parameters), and whether one or more of the set of associated identifiers are associated with a current set (e.g., a first set) of additional conditions of a network entity 105 or a future set (e.g., a second set) of additional conditions. For example, the network entity 105 may transmit (e.g., signal, indicate) a list of associated IDs, and the control message may further indicate whether each associated ID included in the list of associated ID(s) is a current or future associated ID (e.g., whether a respective associated ID represents a current or future network-side additional condition). In some aspects, the information indicating whether an associated ID is a current or future associated ID may be conveyed to the UE explicitly or implicitly. As an example, the associated IDs indicated by the control message may each be accompanied by a flag representing whether the associated IDs are related to current or future network-side additional conditions. In another example, whether an associated ID is related to current or future network-side additional conditions may be indicated via an ordering of the associated IDs, where a first associated ID (or first quantity of associated IDs) in the list may be related to current additional conditions, and the remaining associated IDs may be related to future additional conditions. In any case (e.g., for both implicit and explicit indications), future associated IDs (e.g., non-current associated IDs) may be indicated with different levels of priority, which may assist the UE in prioritizing downloading the AI/ML models/functionalities related to relatively higher priority associated IDs. In some aspects, non-current associated IDs (e.g., future associated IDs) may be related to one or more neighboring cells, and the associated IDs for the neighboring cells may be indicated via a flag.

In some aspects, the UE 115-a may receive an indication of priority across associated ID included in the list of associated IDs. Additionally, or alternatively, the UE 115-a may receive an indication of a priority across inference configurations (e.g., across multiple CSI-ReportConfig) of one or more current associated IDs. The priority may be configured by the network entity across different associated IDs, and may be used by the UE 115-a to determine which associated ID(s) to prioritize (such as without indicating explicitly what is current associated ID, where a higher priority is implicitly assumed for a current associated ID). In some aspects, within a same associated ID, the priority may be provided to different configurations or inference-related parameters (such as in the case where there may be more than one CSI-ReportConfig or inference related parameters for a single associated ID).

At 420, the UE 115 may obtain (e.g., download) one or more AI/ML models/functionalities and/or one or more inference configurations that correspond to the associated ID(s) that are indicated at 415. The UE 115 may obtain the models and/or configurations, for example, from one or more servers or via other sources or methods.

At 425, the UE 115 may transmit, and the network entity 105 may receive, a reporting message including an indication of whether at least one set of AI/ML configurations or at least one set of inference parameters from the one or more parameters applicable for prediction operations (or is ready to be activated for beam prediction and/or other operations). In some examples, the at least one set of AI/ML configurations or the at least one set of inference parameters is applicable based on the set of associated IDs, the one or more configurations, the one or more parameters, whether the one or more of the set of associated ID are associated with the current set of additional conditions (e.g., whether associated IDs are associated with current or future additional conditions) or associated with the future set of additional conditions, or any combination thereof.

At 430, the network entity 105 may transmit, and the UE 115 may receive, an activation command for AP/SP CSI reporting, where one or more functionalities and/or configurations may be activated via the activation message. In some aspects, one or more of the applicable configurations indicated at 425 may be activated (e.g., based on the reporting message). The UE 115 may use one or more AI/ML configurations for the beam prediction in accordance with the at least one set of AI/ML configurations indicated by the reporting message (and in response to an activation of such AI/ML configurations).

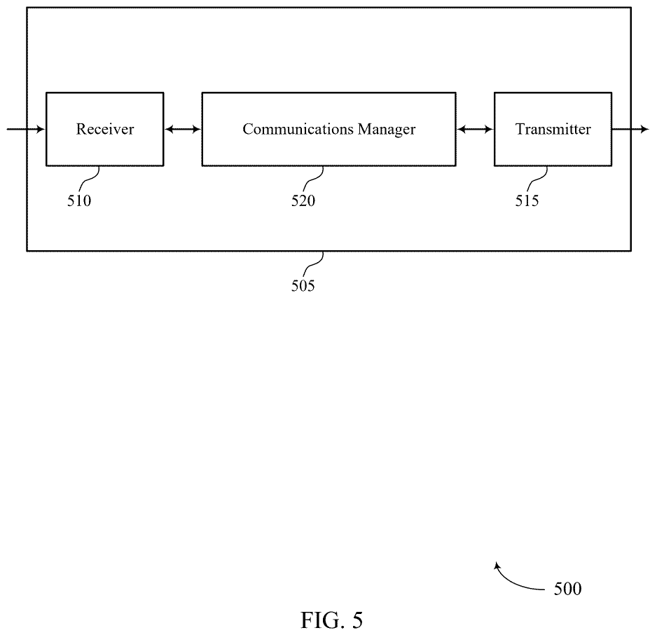

FIG. 5 shows a block diagram 500 of a device 505 that supports indicating current and future associated identifiers for beam prediction in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to indicating current and future associated identifiers for beam prediction). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to indicating current and future associated identifiers for beam prediction). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of indicating current and future associated identifiers for beam prediction as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a first control message indicating a set of associated identifiers, one or more configurations for prediction operations or one or more parameters associated with the prediction operations, and whether one or more of the set of associated identifiers are associated with a first set of additional conditions of a network entity or a second set of additional conditions. The communications manager 520 is capable of, configured to, or operable to support a means for transmitting a reporting message including an indication of whether at least one set of machine learning configurations or at least one set of prediction parameters from the one or more parameters is applicable for the prediction operations, where the at least one set of machine learning configurations or the at least one set of prediction parameters is applicable based on the set of associated identifiers, the one or more configurations, the one or more parameters, whether the one or more of the set of associated identifiers are associated with the first set of additional conditions or the second set of additional conditions, or any combination thereof. The communications manager 520 is capable of, configured to, or operable to support a means for receiving a second control message activating one or more machine learning configurations in accordance with the reporting message. The communications manager 520 is capable of, configured to, or operable to support a means for using the one or more machine learning configurations for the prediction operations in accordance with the at least one set of machine learning configurations indicated by the reporting message.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, and more efficient utilization of communication resources, among other examples. As an example, after receiving the applicability information for a given associated ID (plus inference configuration/inference related parameters), signaling included in Step 3, as described with reference to FIG. 4, may not be repeated for future associated IDs (which may entail the latency associated with RRC reconfiguration and UE downloading the appropriate model), and the network may immediately activate the corresponding functionality for beam prediction.

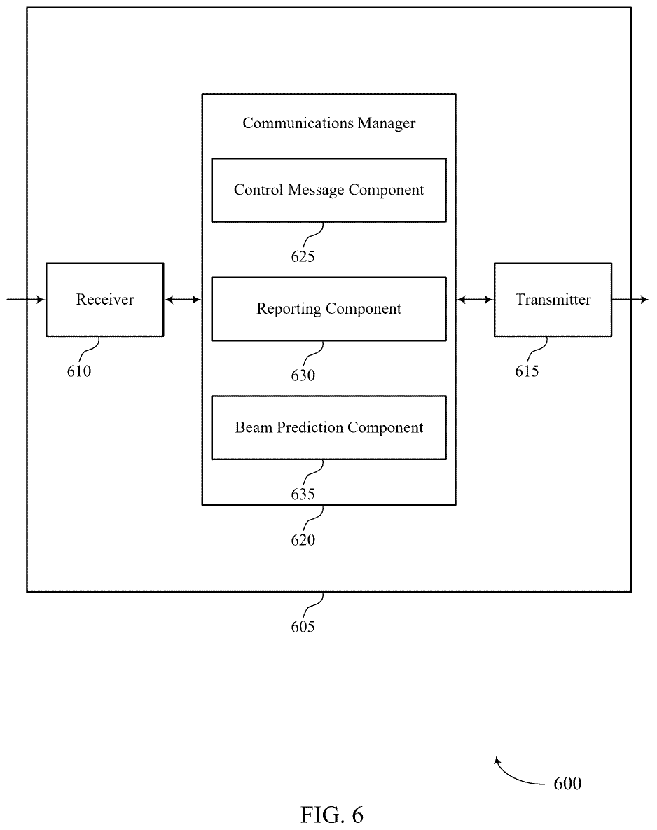

FIG. 6 shows a block diagram 600 of a device 605 that supports indicating current and future associated identifiers for beam prediction in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to indicating current and future associated identifiers for beam prediction). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to indicating current and future associated identifiers for beam prediction). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of indicating current and future associated identifiers for beam prediction as described herein. For example, the communications manager 620 may include a control message component 625, a reporting component 630, a beam prediction component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The control message component 625 is capable of, configured to, or operable to support a means for receiving a first control message indicating a set of associated identifiers, one or more configurations for prediction operations or one or more parameters associated with the prediction operations, and whether one or more of the set of associated identifiers are associated with a first set of additional conditions of a network entity or a second set of additional conditions. The reporting component 630 is capable of, configured to, or operable to support a means for transmitting a reporting message including an indication of whether at least one set of machine learning configurations or at least one set of prediction parameters from the one or more parameters is applicable for the prediction operations, where the at least one set of machine learning configurations or the at least one set of prediction parameters is applicable in accordance with (e.g., when the at least one set of machine learning configurations or the at least one set of prediction parameters may be used with) the set of associated identifiers, the one or more configurations, the one or more parameters, whether the one or more of the set of associated identifiers are associated with the first set of additional conditions or the second set of additional conditions, or any combination thereof. The control message component 625 is capable of, configured to, or operable to support a means for receiving a second control message activating one or more machine learning configurations in accordance with the reporting message. The beam prediction component 635 is capable of, configured to, or operable to support a means for using the one or more machine learning configurations for the prediction operations in accordance with the at least one set of machine learning configurations indicated by the reporting message.

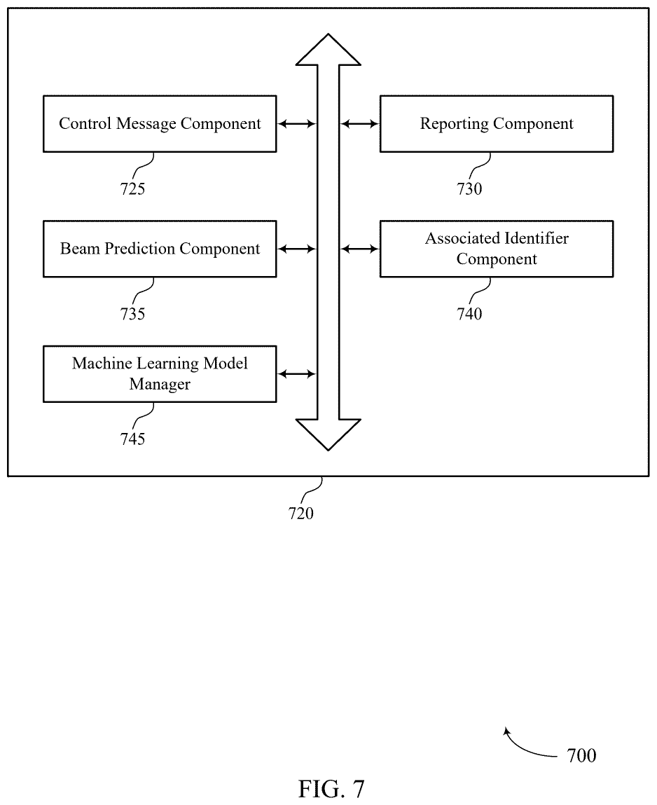

FIG. 7 shows a block diagram 700 of a communications manager 720 that supports indicating current and future associated identifiers for beam prediction in accordance with one or more aspects of the present disclosure. The communications manager 720 may be an example of aspects of a communications manager 520, a communications manager 620, or both, as described herein. The communications manager 720, or various components thereof, may be an example of means for performing various aspects of indicating current and future associated identifiers for beam prediction as described herein. For example, the communications manager 720 may include a control message component 725, a reporting component 730, a beam prediction component 735, an associated identifier component 740, a machine learning model manager 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The control message component 725 is capable of, configured to, or operable to support a means for receiving a first control message indicating a set of associated identifiers, one or more configurations for prediction operations or one or more parameters associated with the prediction operations, and whether one or more of the set of associated identifiers are associated with a first set of additional conditions of a network entity or a second set of additional conditions. The reporting component 730 is capable of, configured to, or operable to support a means for transmitting a reporting message including an indication of whether at least one set of machine learning configurations or at least one set of prediction parameters from the one or more parameters is applicable for the prediction operations, where the at least one set of machine learning configurations or the at least one set of prediction parameters is applicable based on the set of associated identifiers, the one or more configurations, the one or more parameters, whether the one or more of the set of associated identifiers are associated with the first set of additional conditions or the second set of additional conditions, or any combination thereof. In some examples, the control message component 725 is capable of, configured to, or operable to support a means for receiving a second control message activating one or more machine learning configurations in accordance with the reporting message. The beam prediction component 735 is capable of, configured to, or operable to support a means for using the one or more machine learning configurations for the prediction operations in accordance with the at least one set of machine learning configurations indicated by the reporting message.

In some examples, the indication of the reporting message may indicate whether the at least one set of machine learning configurations or the at least one set of prediction parameters from the one or more parameters is ready for one or more prediction operations, whether the at least one set of machine learning configurations or the at least one set of prediction parameters from the one or more parameters is obtainable for one or more prediction operations after a duration, or whether the at least one set of machine learning configurations or the at least one set of prediction parameters from the one or more parameters is not applicable for one or more prediction operations

In some examples, the first set of additional conditions may include a current set of additional conditions and the second set of additional conditions may include a future set of additional conditions of the network entity.

In some examples, the first set of additional conditions may correspond to a serving cell associated with the network entity and the second set of additional conditions may correspond to an adjacent cell associated with a second network entity.

In some examples, the one or more configurations may include the set of associated identifiers, and the one or more configurations may include one or more channel state information report configurations that include predictive information.

In some examples, the prediction operations may be or may include a beam prediction, a CSI prediction, or any combination thereof. In some examples, the set of associated identifiers may be indicated via the one or more configurations for prediction operations.

In some examples, the first control message indicates a priority of each of the one or more of the set of associated identifiers, and the associated identifier component 740 is capable of, configured to, or operable to support a means for selecting at least one associated identifier from the one or more of the set of associated identifiers in accordance with the priority.

In some examples, the first control message indicates a first associated identifier of the one or more of the set of associated identifiers for the current set of additional conditions. In some examples, the first control message further indicates a priority of one or more channel state information report configurations corresponding to the first associated identifier, a priority of one or more inference parameters corresponding to the first associated identifier, or any combination thereof. In some examples, the at least one set of machine learning configurations or the at least one set of inference parameters indicated via the reporting message corresponds to the priority of the one or more channel state information report configurations, the priority of the one or more inference parameters, or both.

In some examples, the first control message includes a respective flag for each associated identifier of the set of associated identifiers. In some examples, the respective flag includes a first value indicating that a corresponding associated identifier is associated with the current set of additional conditions or including a second value indicating that the corresponding associated identifier is associated with a future set of additional conditions of the network entity.

In some examples, the set of associated identifiers are indicated by the first control message in accordance with an order of respective associated identifiers. In some examples, the order is indicative of whether a respective associated identifier is associated with the current set of additional conditions of the network entity or is associated with a future set of additional conditions of the network entity.

In some examples, the reporting component 730 is capable of, configured to, or operable to support a means for transmitting a message including an indication that one or more of the at least one set of machine learning configurations are no longer applicable for one or more additional inference operations for the beam prediction.

In some examples, the message is transmitted via radio resource control signaling, via medium access control-control element signaling, via uplink control information, or any combination thereof, based on the one or more of the at least one set of machine learning configurations being previously indicated as ready to be activated.

In some examples, the indication that the one or more of the at least one set of machine learning configurations are no longer applicable is based on whether the one or more of the set of associated identifiers are associated with the current set of additional conditions of the network entity, a priority of each of the one or more of the set of associated identifiers, whether an associated identifier corresponding to the one or more of the at least one set of machine learning configurations is associated with a neighboring cells, or any combination thereof.

In some examples, the machine learning model manager 745 is capable of, configured to, or operable to support a means for obtaining a machine learning model that corresponds to at least one associated identifier of the one or more of the set of associated identifiers based on the first control message indicating that the one or more of the set of associated identifiers is associated with the current set of additional conditions.

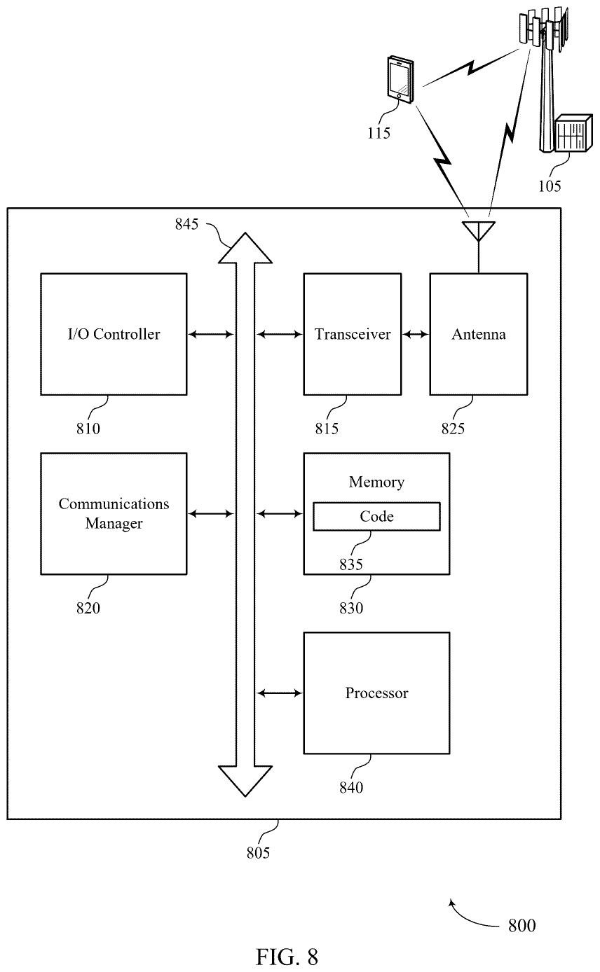

FIG. 8 shows a diagram of a system 800 including a device 805 that supports indicating current and future associated identifiers for beam prediction in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting indicating current and future associated identifiers for beam prediction). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a first control message indicating a set of associated identifiers, one or more configurations for prediction operations or one or more parameters associated with the prediction operations, and whether one or more of the set of associated identifiers are associated with a first set of additional conditions of a network entity or a second set of additional conditions. The communications manager 820 is capable of, configured to, or operable to support a means for transmitting a reporting message including an indication of whether at least one set of machine learning configurations or at least one set of prediction parameters from the one or more parameters is applicable for the prediction operations, where the at least one set of machine learning configurations or the at least one set of prediction parameters is applicable based on the set of associated identifiers, the one or more configurations, the one or more parameters, whether the one or more of the set of associated identifiers are associated with the first set of additional conditions or the second set of additional conditions, or any combination thereof. The communications manager 820 is capable of, configured to, or operable to support a means for receiving a second control message activating one or more machine learning configurations in accordance with the reporting message. The communications manager 820 is capable of, configured to, or operable to support a means for using the one or more machine learning configurations for the prediction operations in accordance with the at least one set of machine learning configurations indicated by the reporting message.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, improved utilization of processing capability, among other examples. As an example, after receiving the applicability information for a given associated ID (plus inference configuration/inference related parameters), signaling included in Step 3, as described with reference to FIG. 4, may not be repeated for future associated IDs (which may entail the latency associated with RRC reconfiguration and UE downloading the appropriate model), and the network may immediately activate the corresponding functionality for beam prediction.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of indicating current and future associated identifiers for beam prediction as described herein, or the at least one processor 840 and the at least one memory 830 may be otherwise configured to, individually or collectively, perform or support such operations.

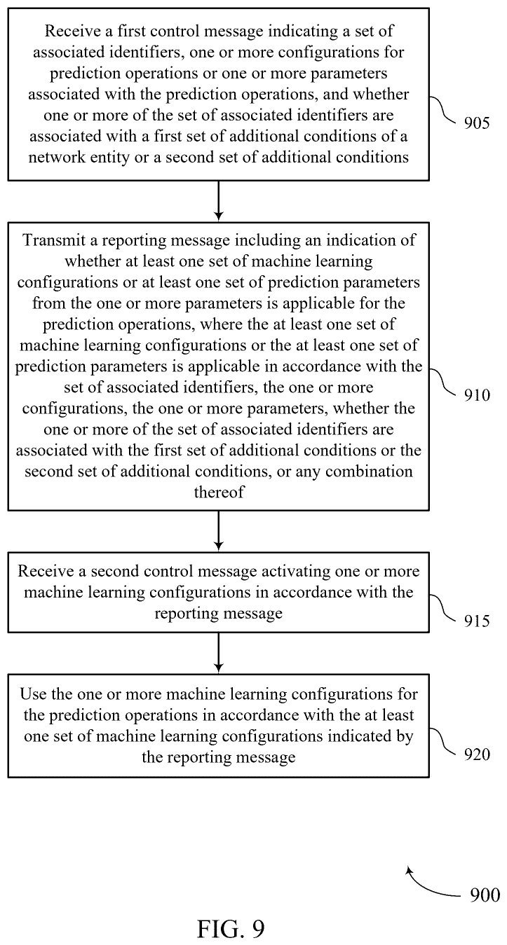

FIG. 9 shows a flowchart illustrating a method 900 that supports indicating current and future associated identifiers for beam prediction in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving a first control message indicating a set of associated identifiers, one or more configurations for prediction operations or one or more parameters associated with the prediction operations, and whether one or more of the set of associated identifiers are associated with a first set of additional conditions of a network entity or a second set of additional conditions. The operations of 905 may be performed in accordance with examples as disclosed herein. In some examples, aspects of the operations of 905 may be performed by a control message component 725 as described with reference to FIG. 7.

At 910, the method may include transmitting a reporting message including an indication of whether at least one set of machine learning configurations or at least one set of prediction parameters from the one or more parameters is applicable for the prediction operations, where the at least one set of machine learning configurations or the at least one set of prediction parameters is applicable based on the set of associated identifiers, the one or more configurations, the one or more parameters, whether the one or more of the set of associated identifiers are associated with the first set of additional conditions or the second set of additional conditions, or any combination thereof. The operations of 910 may be performed in accordance with examples as disclosed herein. In some examples, aspects of the operations of 910 may be performed by a reporting component 730 as described with reference to FIG. 7.

At 915, the method may include receiving a second control message activating one or more machine learning configurations in accordance with the reporting message. The operations of 915 may be performed in accordance with examples as disclosed herein. In some examples, aspects of the operations of 915 may be performed by a control message component 725 as described with reference to FIG. 7.

At 920, the method may include using the one or more machine learning configurations for the prediction operations in accordance with the at least one set of machine learning configurations indicated by the reporting message. The operations of 920 may be performed in accordance with examples as disclosed herein. In some examples, aspects of the operations of 920 may be performed by a beam prediction component 735 as described with reference to FIG. 7.

The following provides an overview of aspects of the present disclosure:

Aspect 1: A method for wireless communication by a UE, comprising:
receiving a first control message indicating: a set of associated identifiers, one or more configurations for prediction operations or one or more parameters associated with the prediction operations, and whether one or more of the set of associated identifiers are associated with a first set of additional conditions of a network entity or a second set of additional conditions; transmitting a reporting message comprising an indication of whether at least one set of machine learning configurations or at least one set of prediction parameters from the one or more parameters is applicable for the prediction operations, wherein the at least one set of machine learning configurations or the at least one set of prediction parameters is applicable in accordance with the set of associated identifiers, the one or more configurations, the one or more parameters, whether the one or more of the set of associated identifiers are associated with the first set of additional conditions or the second set of additional conditions, or any combination thereof;
receiving a second control message activating one or more machine learning configurations in accordance with the reporting message; and using the one or more machine learning configurations for the prediction operations in accordance with the at least one set of machine learning configurations indicated by the reporting message.

Aspect 2: The method of aspect 1, wherein the indication of the reporting message indicates whether the at least one set of machine learning configurations or the at least one set of prediction parameters from the one or more parameters is ready for one or more prediction operations; the at least one set of machine learning configurations or the at least one set of prediction parameters from the one or more parameters is obtainable for one or more prediction operations after a duration; or the at least one set of machine learning configurations or the at least one set of prediction parameters from the one or more parameters is not applicable for one or more prediction operations.

Aspect 3: The method of any of aspects 1 through 2, wherein the first set of additional conditions comprises a current set of additional conditions and the second set of additional conditions comprises a future set of additional conditions of the network entity.

Aspect 4: The method of any of aspects 1 through 3, wherein the first set of additional conditions corresponds to a serving cell associated with the network entity and the second set of additional conditions corresponds to an adjacent cell associated with a second network entity.

Aspect 5: The method of any of aspects 1 through 4, wherein the one or more configurations include the set of associated identifiers, and the one or more configurations comprise one or more channel state information report configurations that include predictive information.

Aspect 6: The method of any of aspects 1 through 5, wherein the prediction operations comprise a beam prediction or a CSI prediction, or any combination thereof.

Aspect 7: The method of any of aspects 1 through 6, wherein the first control message indicates a priority of each of the one or more of the set of associated identifiers, the method further comprising: selecting at least one associated identifier from the one or more of the set of associated identifiers in accordance with the priority.

Aspect 8: The method of any of aspects 1 through 7, wherein the first control message indicates a first associated identifier of the one or more of the set of associated identifiers for the first set of additional conditions, and the first control message further indicates a priority of one or more channel state information report configurations corresponding to the first associated identifier, a priority of one or more prediction parameters corresponding to the first associated identifier, or any combination thereof, and the at least one set of machine learning configurations or the at least one set of prediction parameters indicated via the reporting message corresponds to the priority of the one or more channel state information report configurations, the priority of the one or more prediction parameters, or both.

Aspect 9: The method of any of aspects 1 through 8, wherein the first control message comprises a respective flag for each associated identifier of the set of associated identifiers, and the respective flag comprises a first value indicating that a corresponding associated identifier is associated with the first set of additional conditions or comprising a second value indicating that the corresponding associated identifier is associated with the second set of additional conditions of the network entity.

Aspect 10: The method of any of aspects 1 through 9, wherein the set of associated identifiers are indicated by the first control message in accordance with an order of respective associated identifiers, and the order is indicative of whether a respective associated identifier is associated with the first set of additional conditions of the network entity or is associated with the second set of additional conditions of the network entity.

Aspect 11: The method of any of aspects 1 through 10, further comprising:
transmitting a message comprising an indication that one or more of the at least one set of machine learning configurations are no longer applicable for one or more additional prediction operations for the prediction.

Aspect 12: The method of aspect 11, wherein the message is transmitted via radio resource control signaling, via medium access control-control element signaling, via uplink control information, or any combination thereof, in accordance with the one or more of the at least one set of machine learning configurations being previously indicated as applicable.

Aspect 13: The method of any of aspects 11 through 12, wherein the indication that the one or more of the at least one set of machine learning configurations are no longer applicable is based at least in part on whether the one or more of the set of associated identifiers are associated with the first set of additional conditions of the network entity or the second set of additional conditions, a priority of each of the one or more of the set of associated identifiers, whether an associated identifier corresponding to the one or more of the at least one set of machine learning configurations is associated with a neighboring cells, or any combination thereof.

Aspect 14: The method of any of aspects 1 through 13, further comprising:
obtaining a machine learning model that corresponds to at least one associated identifier of the one or more of the set of associated identifiers in accordance with the first control message indicating that the one or more of the set of associated identifiers is associated with the first set of additional conditions.
Aspect 15: The method of any of aspects 1 through 14, wherein the set of associated identifiers are indicated via the one or more configurations for prediction operations.

Aspect 16: A UE for wireless communication, comprising a processing system that includes processor circuitry and memory circuitry that stores code, the processing system configured to cause the UE to perform a method of any of aspects 1 through 15.

Aspect 17: A UE for wireless communication, comprising at least one means for performing a method of any of aspects 1 through 15.

Aspect 18: A non-transitory computer-readable medium storing code for wireless communication, the code comprising instructions executable by one or more processors to perform a method of any of aspects 1 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a first control message indicating:
a set of associated identifiers,
one or more configurations for prediction operations or one or more parameters associated with the prediction operations, and
whether one or more of the set of associated identifiers are associated with a first set of additional conditions of a network entity or a second set of additional conditions;
transmit a reporting message comprising an indication of whether at least one set of machine learning configurations or at least one set of prediction parameters from the one or more parameters is applicable for the prediction operations,
wherein the at least one set of machine learning configurations or the at least one set of prediction parameters is applicable in accordance with the set of associated identifiers, the one or more configurations, the one or more parameters, whether the one or more of the set of associated identifiers are associated with the first set of additional conditions or the second set of additional conditions, or any combination thereof;
receive a second control message activating one or more machine learning configurations in accordance with the reporting message; and
use the one or more machine learning configurations for the prediction operations in accordance with the at least one set of machine learning configurations indicated by the reporting message.

2. The UE of claim 1, wherein the indication of the reporting message indicates whether:
the at least one set of machine learning configurations or the at least one set of prediction parameters from the one or more parameters is ready for one or more prediction operations;
the at least one set of machine learning configurations or the at least one set of prediction parameters from the one or more parameters is obtainable for one or more prediction operations after a duration; or
the at least one set of machine learning configurations or the at least one set of prediction parameters from the one or more parameters is not applicable for one or more prediction operations.

3. The UE of claim 1, wherein the first set of additional conditions comprises a current set of additional conditions and the second set of additional conditions comprises a future set of additional conditions of the network entity.

4. The UE of claim 1, wherein the first set of additional conditions corresponds to a serving cell associated with the network entity and the second set of additional conditions corresponds to an adjacent cell associated with a second network entity.

5. The UE of claim 1, wherein the one or more configurations include the set of associated identifiers, and wherein the one or more configurations comprise one or more channel state information report configurations that include predictive information.

6. The UE of claim 1, wherein the prediction operations comprise a beam prediction or a CSI prediction, or any combination thereof.

7. The UE of claim 1, wherein the first control message indicates a priority of each of the one or more of the set of associated identifiers, and wherein the one or more processors are individually or collectively operable to cause the UE to:
select at least one associated identifier from the one or more of the set of associated identifiers in accordance with the priority.

8. The UE of claim 1, wherein the first control message indicates a first associated identifier of the one or more of the set of associated identifiers for the first set of additional conditions, and the first control message further indicates a priority of one or more channel state information report configurations corresponding to the first associated identifier, a priority of one or more prediction parameters corresponding to the first associated identifier, or any combination thereof, and wherein the at least one set of machine learning configurations or the at least one set of prediction parameters indicated via the reporting message corresponds to the priority of the one or more channel state information report configurations, the priority of the one or more prediction parameters, or both.

9. The UE of claim 1, wherein the first control message comprises a respective flag for each associated identifier of the set of associated identifiers, and wherein the respective flag comprises a first value indicating that a corresponding associated identifier is associated with the first set of additional conditions or comprising a second value indicating that the corresponding associated identifier is associated with the second set of additional conditions of the network entity.

10. The UE of claim 1, wherein the set of associated identifiers are indicated by the first control message in accordance with an order of respective associated identifiers, and wherein the order is indicative of whether a respective associated identifier is associated with the first set of additional conditions of the network entity or is associated with the second set of additional conditions of the network entity.

11. The UE of claim 1, wherein the one or more processors are individually or collectively further operable to cause the UE to:
transmit a message comprising an indication that one or more of the at least one set of machine learning configurations are no longer applicable for one or more additional prediction operations for the prediction.

12. The UE of claim 11, wherein the message is transmitted via radio resource control signaling, via medium access control-control element signaling, via uplink control information, or any combination thereof, in accordance with the one or more of the at least one set of machine learning configurations being previously indicated as applicable.

13. The UE of claim 11, wherein the indication that the one or more of the at least one set of machine learning configurations are no longer applicable is based at least in part on whether the one or more of the set of associated identifiers are associated with the first set of additional conditions of the network entity or the second set of additional conditions, a priority of each of the one or more of the set of associated identifiers, whether an associated identifier corresponding to the one or more of the at least one set of machine learning configurations is associated with a neighboring cells, or any combination thereof.

14. The UE of claim 1, wherein the one or more processors are individually or collectively further operable to cause the UE to:
obtain a machine learning model that corresponds to at least one associated identifier of the one or more of the set of associated identifiers in accordance with the first control message indicating that the one or more of the set of associated identifiers is associated with the first set of additional conditions.

15. The UE of claim 1, wherein the set of associated identifiers are indicated via the one or more configurations for prediction operations.

16. A method for wireless communications by a user equipment (UE), comprising:
receiving a first control message indicating:
a set of associated identifiers,
one or more configurations for prediction operations or one or more parameters associated with the prediction operations, and
whether one or more of the set of associated identifiers are associated with a first set of additional conditions of a network entity or a second set of additional conditions;
transmitting a reporting message comprising an indication of whether at least one set of machine learning configurations or at least one set of prediction parameters from the one or more parameters is applicable for the prediction operations,
wherein the at least one set of machine learning configurations or the at least one set of prediction parameters is applicable in accordance with the set of associated identifiers, the one or more configurations, the one or more parameters, whether the one or more of the set of associated identifiers are associated with the first set of additional conditions or the second set of additional conditions, or any combination thereof;
receiving a second control message activating one or more machine learning configurations in accordance with the reporting message; and
using the one or more machine learning configurations for the prediction operations in accordance with the at least one set of machine learning configurations indicated by the reporting message.

17. The method of claim 16, wherein the indication of the reporting message indicates whether:
the at least one set of machine learning configurations or the at least one set of prediction parameters from the one or more parameters is ready for one or more prediction operations;
the at least one set of machine learning configurations or the at least one set of prediction parameters from the one or more parameters is obtainable for one or more prediction operations after a duration; or
the at least one set of machine learning configurations or the at least one set of prediction parameters from the one or more parameters is not applicable for one or more prediction operations.

18. The method of claim 16, wherein the first set of additional conditions comprises a current set of additional conditions and the second set of additional conditions comprises a future set of additional conditions of the network entity.

19. The method of claim 16, wherein the first set of additional conditions corresponds to a serving cell associated with the network entity and the second set of additional conditions corresponds to an adjacent cell associated with a second network entity.

20. A non-transitory computer-readable medium storing code for wireless communications, the code comprising instructions executable by one or more processors to:
receive a first control message indicating:
a set of associated identifiers,
one or more configurations for prediction operations or one or more parameters associated with the prediction operations, and
whether one or more of the set of associated identifiers are associated with a first set of additional conditions of a network entity or a second set of additional conditions;
transmit a reporting message comprising an indication of whether at least one set of machine learning configurations or at least one set of prediction parameters from the one or more parameters is applicable for the prediction operations,
wherein the at least one set of machine learning configurations or the at least one set of prediction parameters is applicable in accordance with the set of associated identifiers, the one or more configurations, the one or more parameters, whether the one or more of the set of associated identifiers are associated with the first set of additional conditions or the second set of additional conditions, or any combination thereof;
receive a second control message activating one or more machine learning configurations in accordance with the reporting message; and
use the one or more machine learning configurations for the prediction operations in accordance with the at least one set of machine learning configurations indicated by the reporting message.
